(19) United States
(12) Patent Application Publication
(10) Pub. No.: US 2014/0150603 A1
(43) Pub. Date: Jun. 5, 2014

(54) Systems for an Alternative Fuel, Electric Drive Vehicle

(71) Applicant: Rick M. Saccone, Akron, OH (US)

(72) Inventor: Rick M. Saccone, Akron, OH (US)

(73) Assignee: Hydrogen Energy Systems, LLC, Akron, OH (US)

(21) Appl. No.: 13/922,221

(22) Filed: Jun. 19, 2013

Related U.S. Application Data
(63) Continuation-in-part of application No. 13/236,263, filed on Sep. 19, 2011.
(60) Provisional application No. 61/661,653, filed on Jun. 19, 2012.

(51) Int. Cl. B60K 6/42

(52) U.S. Cl. CPC B60K 6/42; Y10S 903/902
USPC 74/661; 180/65.22; 903/902

(57) ABSTRACT

A propulsion system including an alternative fuel engine that propels a vehicle with an electric dc motor coupled to the vehicle's transmission.

This application claims priority to U.S. Provisional Application No. 61/661,653 filed Jun. 19, 2012 and is a continuation in part of U.S. patent application Ser. No. 13/236,263 filed Sep. 19, 2011.

There is a growing need in the internal combustion arts to improve engine longevity, reduce emissions and lessen dependence on fuels or raw materials from less stable trading partners. Modifications to systems including a fuel source, an internal combustion engine and a drive mechanism are detailed below to accomplish some or all of these.

The accompanying drawings, which are incorporated in and constitute a part of the specification, illustrate various example systems, methods, and so on that illustrates various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements in the drawings may not be to scale, emphasis instead being placed upon clearly illustrating the principles of the present disclosure.

### BRIEF DESCRIPTION OF DRAWINGS

FIG. 1 is a perspective view of an exemplary mixing block.

FIG. 2 is a cross-sectional view of an exemplary mixing block.

FIG. 3 is an exploded view of an embodiment of a slider assembly.

FIG. 4 is bottom plan view taken along lines IV-IV of FIG. 3.

FIG. 5 is top plan view taken along lines V-V of FIG. 3.

FIG. 6 is top plan view of an exemplary mixing block.

FIG. 7 is a view of an internal combustion engine system.

FIG. 8 is a chart of cubic feet per hour hydrogen use at exemplary RPM's on a sample internal combustion engine.

FIG. 9 is a view of an embodiment of vehicle propulsion system.

### DETAILED DESCRIPTION

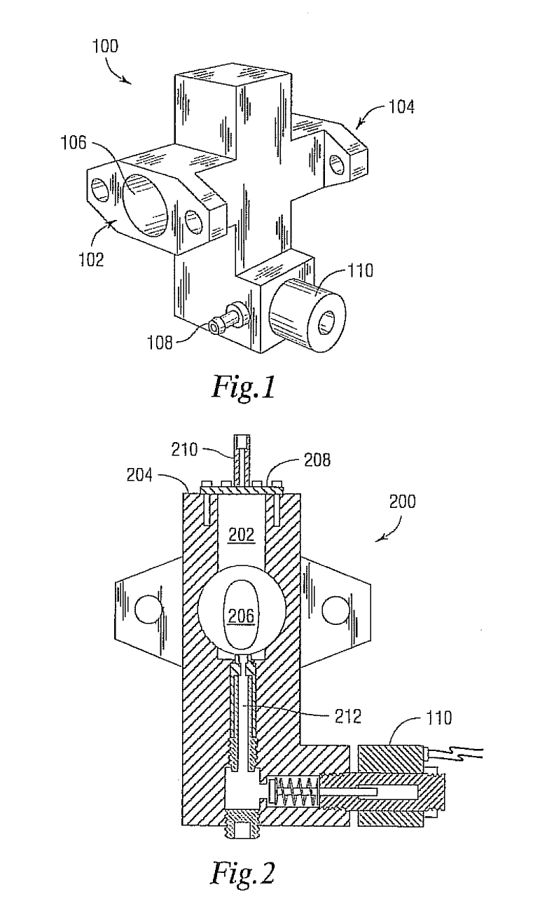

With reference to FIG. 1, an exemplary fuel source and air mixing block 100 is shown. The mixing block 100 may be machined, cast, injection molded or otherwise formed to comprise an air intake side 102 which may be configured for attachment with an air-filter (not shown) to reduce particle or other contaminant entry into the mixing block. The mixing block 100 may also comprise an engine intake side 104 configured for connection with a fuel/air intake of an internal combustion engine (not shown). A bore 106 is formed through the mixing block 100 between the air intake side 102 and the engine intake side 104. Mixing block 100 additionally includes a gas inlet 108 for connection with a source of gaseous fuel such as hydrogen or natural gas. As will be more completely discussed below, the mixing block 100 may also include a gaseous fuel interrupter, in other words, a fuel shut off shown in FIG. 1 as an electrically controlled solenoid 110.

With reference to FIG. 2, a cross-sectional view of an exemplary mixing block 200 is shown. Formed within mixing block 200 is a slider chamber 202 shaped to accommodate a slider assembly (not shown) more completely described below. Slider chamber 202 extends from a first, top side 204 of the mixing block and continues partially through the mixing block body to intersect bore 206 that extends between the air intake side and the engine intake side. Connected to the top side 204 of the mixing block is a slider cap 208. Slider cap 208 retains interior elements more completely discussed below and permits passage of a throttle cable through stay 210 threaded into slider cap 208. Also formed within mixing block 200 is a jet chamber 212 shaped to accommodate a gas flow-control device (not shown) such as a shaped needle more completely described below. Jet chamber 212 connects the slider chamber 202 and a source of gaseous fuel and permits fluid communication therebetween.

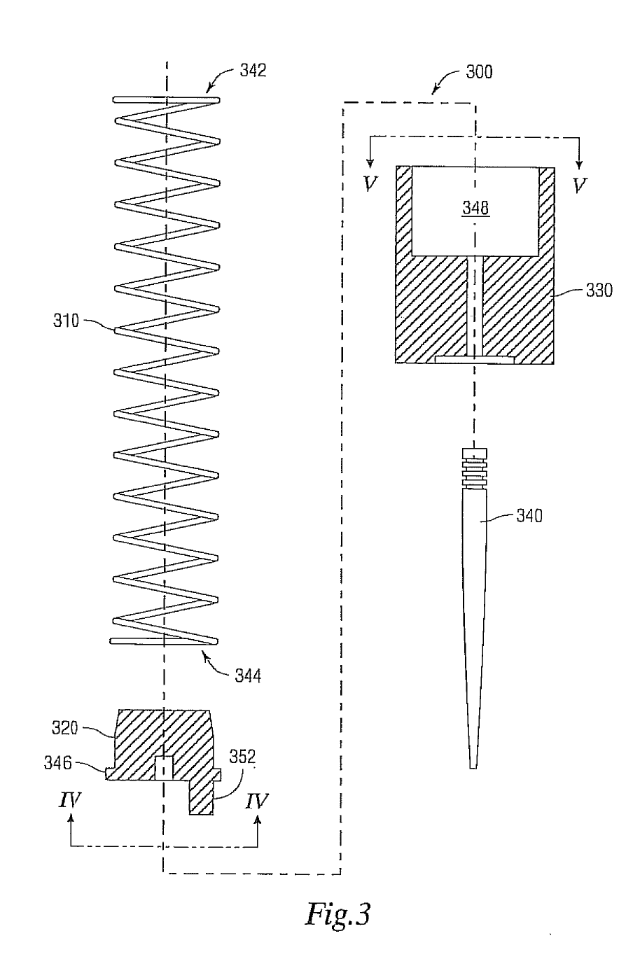

With reference now to FIG. 3, a slider assembly 300 is shown. In the illustrated embodiment, the slider assembly includes a biasing mechanism 310 such as a spring, a retainer 320, a slider 330, and a flow controller 340 such as a shaped needle. When installed in the mixing block, a first side 342 of biasing mechanism 310 is mechanically retained by a slider cap connected to the mixing block. Retainer 320 is disposed on a second side 344 of the biasing mechanism opposite the first side 342. In the illustrated embodiment, retainer 320 includes a circumferential lip 346 to engage biasing mechanism at the second side 344. Retainer 320 is further closely fitted into a retaining cavity 348 formed in slider 330. In one embodiment, retainer 320 includes a lug 352 extending away from retainer and shaped for close fitting into a complementary receptacle (not shown) in the slider 330. Flow controller 340 passes through the slider 330 and is connected to the retainer 320 at a flow controller connection 354. Retainer 320 and flow controller 340 may be integrally made or connected by a clip, threads, and the like. The bias achieved causes the slider 330 to at least partially interrupt the bore between the air intake side and the engine intake side of the bore, reducing or preventing air from passing to the engine while also seating flow controller 340 in the jet chamber, reducing or preventing fuel from passing to the engine. In other embodiments, the slider 330 and complementary shaped slider chamber 202 and/or the bore 106 may be cylindrical as shown, rectangular, conical or other shapes and combinations of shapes capable of providing the desired function.

As best appreciated by reference to FIG. 4, retainer 320 includes an interruption 410 extending partially radially inward and throughout the retainer body to permit a throttle cable to pass through the retainer. Retainer 320 also includes: lug 352 to engage the slider and retain the throttle cable; and a flow controller connection 354.

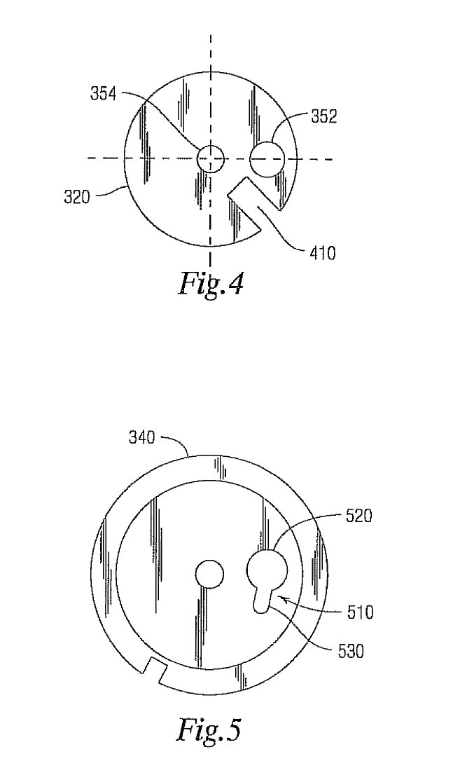

As best appreciated by reference to FIG. 5, slider 330 includes a throttle cable retainer 510. In the illustrated embodiment, throttle cable retainer 510 comprises a key-hole shape to accept a cable-keeper end of a throttle cable. During installation, the cable end is inserted through the larger diameter side 520 and slid to the smaller side 530 to retain the cable end. Once positioned, the lug 352 on retainer 320 is fit into the larger diameter side 520 holding the cable in the slider.

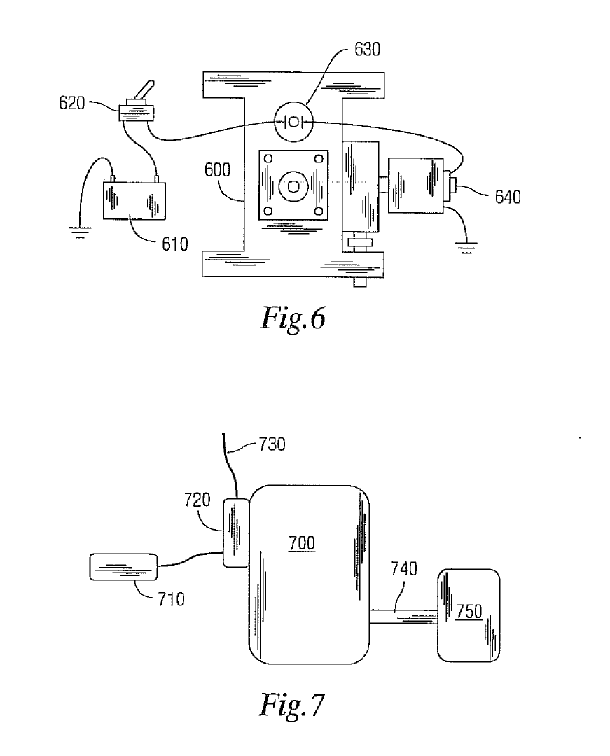

Referring now to FIG. 6, mixing block 600 may additionally include a fuel supply interlock system. In one embodiment, the fuel supply interlock system includes a source of electrical power 610 connected to a user switch 620 that may be user operated to place the system in a safe or in other words no electrical connectivity. User switch 620 can take the form of a toggle-type switch, a key, push button or other electrical circuit interrupters. The user switch 620 is connected in electrical series with a vacuum switch 630. The vacuum switch 630 is disposed on the engine intake side of the mixing block and senses vacuum created when the internal combustion engine turns. When vacuum is sensed, the vacuum switch 630 closes establishing electrical connectivity through the switch. The vacuum switch 630 is connected in electrical series with solenoid 640 and in turn to ground completing the circuit. When energized, solenoid 640 operates to permit fuel into the mixing block 600.

With reference to FIG. 7, an internal combustion engine 700 includes a source of fuel 710 in fluid communication with a mixing block 720. The mixing block sets the fuel/air calibration based on user input including a throttle 730 setting. The internal combustion engine further includes a crank output shaft or driver 740 that may be connected to any known and future varieties of machines 750 capable of being powered by an internal combustion engine including but not limited to a transmission to provide motive power to a vehicle, an alternator or generator to provide electrical power a battery system or electrically powered devices, or a pump for hydraulic or other fluid power devices. In another embodiment, a mixing block may include both an input for a source of liquid hydrocarbon fuels such as gasoline or diesel and a source of gaseous fuel such as hydrogen or natural gas.

Experimental mixing blocks have been applied to multiple internal combustion engines and have accumulated over 400 hours of operation with a fuel source of industrial grade, commercially available hydrogen. Several examples are informative

### EXAMPLE 1-6

### Horsepower (HP) Engine Configured with High Pressure Washer

TABLE 1

| | | | Mixing Block, |
|---|---|---|---|
| | Stock ICE | Mixing Block ICE | Modified ICE |
| Class: | Air Cooled Overhead | Air Cooled Overhead | Air Cooled Overhead |
| | Cam, Chain Drive, ICE | Cam, Chain Drive, ICE | Cam, Chain Drive, |
| | | | ICE |
| Shaft: | Horizontal | Horizontal | Horizontal |
| Cylinders: | 1 | 1 | 1 |
| Displacement: | 169 cc | 169 cc | 169 cc |
| Cycles: | 4 | 4 | 4 |
| Fuel: | Unleaded Gasoline | Hydrogen | Hydrogen |
| Max HP/RPM: | 4.89/4000 (Gross HP) | 2.0/4000 (Gross HP) | 3.7/4000 (Gross HP) |
| Bore × Stroke: | 67 × 48 (mm) | 67 × 48 (mm) | 67 × 48 (mm) |
| Compression: | 9:1 | 9:1 | 10.2:1 |
| Timing: | Factory set | Factory | Advanced |
| Governor | Centrifugal Flyweight | Centrifugal Flyweight | Centrifugal Flyweight |
| System: | | | |
| Fuel System: | Carbureted Float | Mixing block | Mixing block |
| CO₂ Emissions: | 13 PPM | 0 PPM | Not measured** |
| O2 Emissions: | 2.59 PPM | 0 PPM | Not measured** |
| HC Emissions: | 174 PPM | 2 PPM* | Not measured** |
| NOX | 706 PPM | 38 PPM | Not measured** |
| Emissions: | | | |
| CO Emissions: | 2.94 PPM | 0 PPM | Not measured** |

*particulate detected believed to be lubrication oil breakdown
**not believed to materially differ from unmodified mixing block

In the column labeled “Mixing Block ICE,” changes are shown from the stock ICE. Aside from replacing the carburetor with a mixing block, another change from stock was to increase the gap on the spark plug called for by the manufacturer. In this case, we doubled the gap. Additionally, we used a regulator to regulate the pressure from the commercial hydrogen tank (approximately 2200 psi) down to working pressure (about 5 psi). As is seen, there was a slight reduction in observed horse-power in the mixing block modified ICE. In the third column, namely, “Modified Mixing Block ICE,” other modifications were made to improve performance. Specifically, the compression ratio was increased to 10.2:1 through a piston and head change and the timing was advanced by 2 degrees. These changes were able to increase observed horsepower by 1.5 HP. We believe that increasing the compression ratio to 14:1 will further increase observed horsepower.

### EXAMPLE 2-7.5

### HP Engine Configured with Rototiller

TABLE 2

| | Stock ICE | Mixing Block, Modified ICE |
|---|---|---|
| Class: | Air Cooled Overhead | Air Cooled Overhead Cam, |
| | Cam, Chain Drive, | Chain Drive, Gasoline Engine |
| | Gasoline Engine | |
| Shaft: | Horizontal | Horizontal |
| Cylinders: | 1 | 1 |
| Displacement: | 211 cc | 211 cc |
| Cycles: | 4 | 4 |
| Fuel: | Unleaded Gasoline | Hydrogen |
| Max HP/RPM: | 5.1/4000 (Gross HP) | To be determined |
| Bore × Stroke: | 67 × 60 (mm) | 67 × 60 (mm) |
| Compression: | 8.5:1 | 10.2:1 |
| Timing: | Factory set | Advanced |
| Governor | Centrifugal Flyweight | Centrifugal Flyweight |
| System: | | |
| Fuel System: | Throttle Body - | Mixing block |
| | Electronic Fuel Injection | |
| CO₂ Emissions: | 13.2 PPM | 0 PPM |
| O2 Emissions: | 1.35 PPM | 0 PPM |
| HC Emissions: | 149 PPM | 1 PPM* |
| NOX | 426 PPM | 26 PPM |
| Emissions: | | |
| CO Emissions: | 2.38 PPM | 0 PPM |

*particulate detected believed to be lubrication oil breakdown

### EXAMPLE 3-8

### HP Engine Configured with Generator

TABLE 3

| | Stock ICE | Mixing Block ICE |
|---|---|---|
| Class: | Air Cooled Overhead | Air Cooled Overhead Cam, |
| | Cam, Chain Drive, | Chain Drive, Gasoline Engine |
| | Gasoline Engine | |
| Shaft: | Horizontal | Horizontal |
| Cylinders: | 1 | 1 |
| Displacement: | 305 cc | 305 cc |
| Cycles: | 4 | 4 |
| Fuel: | Unleaded Gasoline | Hydrogen |
| Max HP/RPM: | 5.1/4000 (Gross HP) | To be determined |
| Bore × Stroke: | 3.12 × 2.44 (in.) | 3.12 × 2.44 (in.) |
| Compression: | 8.5:1 | 8.5:1 |
| Governor | Centrifugal Flyweight | Centrifugal Flyweight |
| System: | | |
| Fuel System: | Carbureted Float | Mixing block |

### EXAMPLE 4-13.5

### HP Engine Configured with Garden Tractor

TABLE 4

| | Stock ICE | Mixing Block ICE |
|---|---|---|
| Class: | Air Cooled Gasoline | Air Cooled Gasoline Engine |
| | Engine | |
| Shaft: | Vertical | Vertical |
| Cylinders: | 1 | 1 |
| Displacement: | 405 cc | 405 cc |
| Cycles: | 4 | 4 |
| Fuel: | Unleaded Gasoline | Hydrogen |
| Max HP/RPM: | 12/3600 | To be determined |
| Bore × Stroke: | 3.43 × 2.66 (in.) | 3.43 × 2.66 (in.) |
| Compression: | 8.5:1 | 8.5:1 |
| Governor | Centrifugal Flyweight | Centrifugal Flyweight |
| System: | | |
| Fuel System: | Carbureted Float | Mixing block |

### EXAMPLE 5-13

### HP Engine Configured with EZ-Go 6 Passenger Shuttle

TABLE 5

| | Stock ICE | Mixing Block ICE |
|---|---|---|
| Class: | Air Cooled Gasoline | Air Cooled Gasoline Engine |
| | Engine | |
| Shaft: | Horizontal | Horizontal |
| Cylinders: | 1 | 1 |
| Displacement: | 401 cc | 401 cc |
| Cycles: | 4 | 4 |
| Fuel: | Unleaded Gasoline | Hydrogen |
| Max HP/RPM: | 13/3600 | To be determined |
| Bore × Stroke: | 3.43 × 2.66 (in.) | 3.43 × 2.66 (in.) (87 × 67 mm) |
| | (87 × 67 mm) | |
| Compression: | 8.4:1 | 8.4:1 |
| Governor | Centrifugal Flyweight | Centrifugal Flyweight |
| System: | | |
| Fuel System: | Carbureted | Mixing block |

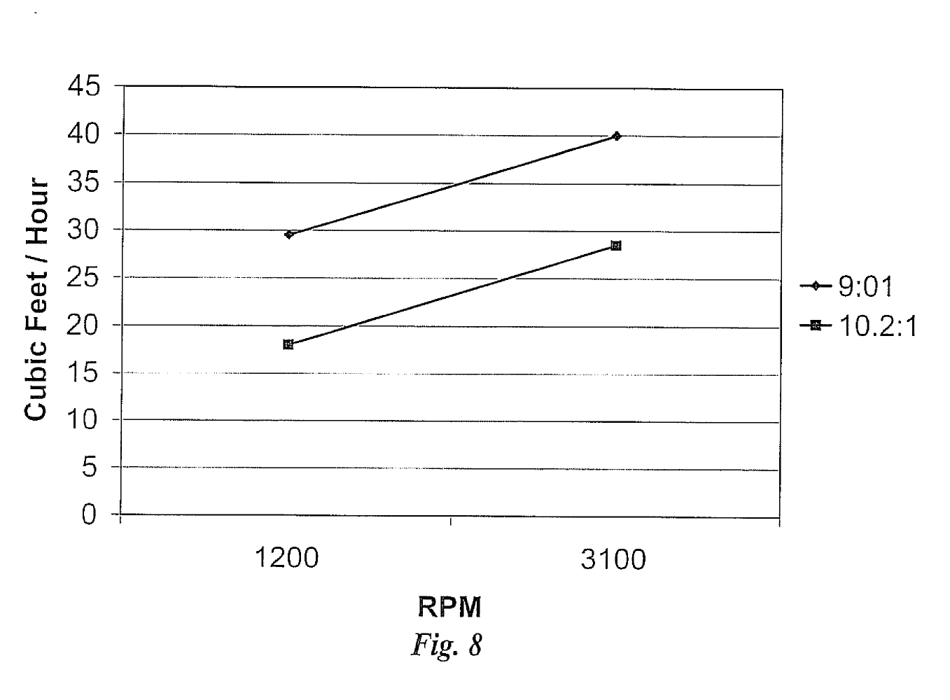

With reference to FIG. 8, hydrogen usage at two exemplary RPM settings, 1200 and 3100 are shown with corresponding fuel consumption measured in cubic feet hydrogen per hour. At 9:1 compression the internal combustion engine used 29.5 cubic feet of hydrogen/hour at an idle set at about 1200 RPM. At a sample working speed of 3100 RPM, the engine used about 40.0 cubic feet of hydrogen/hour. Significant fuel economy was achieved by increasing the compression of the internal combustion engine to 10.2:1. For example, at the selected idle speed 1200 RPM the engine used about 18.0 cubic feet of hydrogen/hour, and at the selected working speed 3100 RPM the engine used about 28.5 cubic feet of hydrogen/hour. We expect further significant fuel economy will be achieved at higher compression ratios.

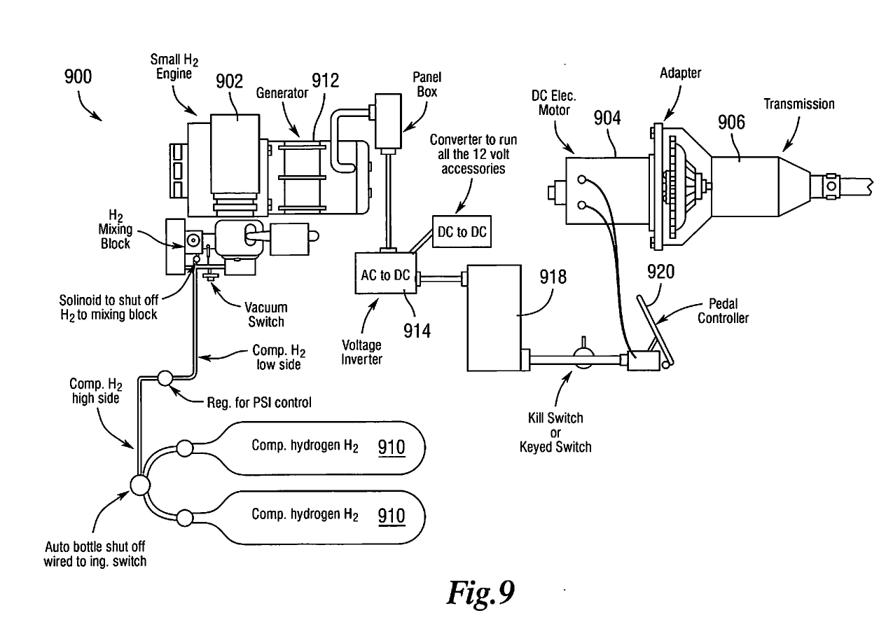

In another embodiment, depicted in FIG. 9, an electric propulsion system 900 for propulsion of certain lawn implements, side-by-sides, cars and trucks, Mass Transit, construction equipment, indeed virtually any system presently powered by an internal combustion or electric motor is provided. The system includes an engine 902 that propels a vehicle (not shown) with an electric dc motor 904 coupled to the transmission 906 of the vehicle. This system, while illustrated with hydrogen tanks 910 may be fueled with other combustible fuels including natural gas or fuel cells. The fuel source 910 provides fuel to a small ice engine 902 that may include a mixing block and safety interlocks as described herein. The engine 902 drives a generator 912 with an inverter 914 changing from AC to DC and powering to a DC battery bank 918 to a pedal controller 920 that may provide a variable resistance signal to run the DC electric motor 904 which is attached to a car, truck or mass transit vehicle. In another, likely smaller power requirement arrangements, the engine 902 can power an alternator or DC generator and directly charge the battery bank 918 without need of an inverter. Such systems has advantages that may include the zero/near-zero emission engine 902 provides vacuum and eliminates the need for a vacuum booster. The engine 902 also may supply power for the power steering. Additionally, conventional electric motors for power steering and brakes may be eliminated saving additional weight and energy being consumed from the batteries. The system 900 is a “charge-as-you-go” energy system which eliminates long charging cycles for the batteries.

Also, the system 900 should greatly reduce manufacture and/or maintenance costs for the vehicle. Brake life is extended as the electric motor operation assists in vehicle control acting as a brake. While most electric vehicles require additional suspension support due to the extra weight of the batteries, in a system 900 as described, there is lower or eliminated need to beef up suspension as the system does not require the same number of batteries as conventional electric vehicles. Less battery weight is also easier on the brakes. Speed depends on the variable resistance signal supplied to the electric motor and the gearing of the transmission. The “charge-as-you-go” technology levels out the stress put on the vehicle components in a long, continuous climb.

In one embodiment, system 900 requires little maintenance as the engine may run on 100% hydrogen. The hydrogen does not generate hydro-carbons to clog the spark plug, or contaminate the oil. Monthly oil checks to make sure the engine has the proper level of oil. The oil does not require changing or at least as frequently, mainly topping off. In the hydrogen embodiment, the spark plug preferably does not include emission control features/metals, and preferably the spark plugs include solid copper core, non-resisted plugs.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

As used herein, “connection” or “connected” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modern Legal Usage 624 (2d. Ed. 1995).

1. A machine comprising:
a DC electric motor suitable to provide motive power to a vehicle;
a DC power source in selective electrical connection with the DC electric motor to enable user control of the DC electric motor;
a power generator electrically connected to the DC power source and capable of charging the DC power source; and
an internal combustion engine connected to operate the power generator, the internal combustion engine including a mixing block having a gaseous fuel source to selectively provide a gaseous fuel/air mixture to the internal combustion engine upon detection of at least a partial vacuum in a cylinder of the internal combustion engine, where the detection of at least a partial vacuum in a cylinder causes gaseous fuel to enter the mixing block.

2. The machine as set forth in claim 1, further comprising a transmission mechanically connected to the DC electric motor at a first end and mechanically connected to a drive train at a second end.

3. The machine as set forth in claim 1, further comprising a source of gaseous fuel.

4. The machine as set forth in claim 1, where the gaseous fuel consists essentially of hydrogen.

5. The machine as set forth in claim 1, where the power generator comprises an AC generator electrically connected to an inverter converting AC power to DC power.

6. The machine as set forth in claim 1, where the power generator comprises an alternator providing DC power.

7. The machine as set forth in claim 1, where the vehicle comprises an automobile.

8. The machine as set forth in claim 1, where the vehicle comprises a mass transit vehicle.

9. The machine as set forth in claim 1, where the vehicle comprises a fork-lift.

10. A machine comprising:
a vehicle body for human transport on land;
an electric motor operably disposed in connection with the vehicle body, the electric motor operably connected to a power source where the electric motor is selectively controlled through a user control in the vehicle body;
a charger electrically connected to the power source and capable of charging the power source; and
a hydrogen fuel control system including a hydrogen fuel source that selectively provides a hydrogen fuel and air mixture to an internal combustion engine physically separated from the electric motor upon detection of a condition in the internal combustion engine,
where the internal combustion engine operates the charger, the internal combustion engine including a mixing block having a hydrogen fuel source to selectively provide the hydrogen fuel and air mixture to the internal combustion engine upon detection of the condition in the internal combustion engine.

11. The machine as set forth in claim 10, where the condition in the internal combustion engine comprises a partial vacuum.
